(19) United States
(12) Patent Application Publication
(10) Pub. No.: US 2021/0283750 A1
(43) Pub. Date: Sep. 16, 2021

(54) LOCKING PLIERS

(71) Applicant: Ming-Chieh WU, Taichung City (TW)

(72) Inventor: Pei-Ching CHANG, Taichung City (TW)

(21) Appl. No.: 17/196,852

(22) Filed: Mar. 9, 2021

(30) Foreign Application Priority Data
Mar. 13, 2020 (TW) 109108430

(51) Int. Cl. B25B 7/12; B25B 7/22; B25B 7/08

(52) U.S. Cl. CPC B25B 7/123; B23D 29/023; B25B 7/08; B25B 7/22

(57) ABSTRACT

A pair of locking pliers includes a first locking unit; a second locking unit including a second handle and a second jaw pivotally connected to the first locking unit and the second handle at a first connecting point and a second connecting point, respectively; a linking member connected to the second handle and the first locking unit at a third connecting point and a fourth connecting point, respectively; and a switching member being convertible relative to the linking member between a blocking position, where the second, third and fourth connecting points are prohibited from becoming collinear, and an unblocking position, where the second, third and fourth connecting points are allowed to become collinear.

### CROSS-REFERENCE TO RELATED APPLICATION

This application claims priority of Taiwanese Patent Application Mo. 109108430, filed on Mar. 13, 2020.

### FIELD

The disclosure relates to a hand tool, and more particularly to a pair of locking pliers.

### BACKGROUND

Referring to FIG. 1, a pair of conventional locking pliers 1 used for clamping an object (not shown) includes a first jaw 11, a first handle 12, an adjustment bolt 13, a second jaw 14, a second handle 15, a connecting member 16, a release lever 17 and a spring member 18.

The first jaw 11 and the first handle 12 are fixedly connected together. The adjustment bolt 13 is threadably engaged with the first handle 12. The second jaw 14 is pivotally connected to the first handle 12 at a first connecting point (A). The second handle 15 is pivotally connected to the second jaw 14 at a second connecting point (B). The connecting member 16 is pivotally connected to the second handle 15 at a third connecting point (C) and abuts against the adjustment bolt 13 at a fourth connecting point (D). The spring member 18 is connected between the second jaw 24 and the first handle 12 for pulling the second jaw 14 towards the first handle 12. The first handle 12, the second jaw 14, the second handle 15 and the connecting member 16 cooperatively form a four-bar linkage structure with the first, second, third and fourth connecting points (A, B, C, D) serving as the four joints of the four-bar linkage structure.

The principal mechanism of such conventional locking pliers 1 is the over-centre clamp (also known as toggle clamp) in which the first and second jaws 11, 14 are maintained at a locked position, as illustrated in FIG. 1, when the third connecting point (C) passes through a dead/toggle point of the four-bar linkage structure (i.e., a point where the second, third and fourth connecting points (B, C, D) become collinear). By pressing the release lever 17 towards the second handle 15, the first and second jaws 11, 14 may be released from the locked position.

In a variation of the conventional locking pliers 1 (not shown), each of the first and second jaws 11, 14 is formed with a bladed portion so that the first and second jaws 11, 14 may be used for cutting (e.g., wire cutting) in addition to clamping objects. However, since the over-centre clamp mechanism, which is designed for clamping, can easily bring the first and second jaws 11, 14 into the locked position, the conventional locking pliers 1 are not ideal for consecutive cutting.

### SUMMARY

Therefore, the object of the disclosure is to provide a pair of locking pliers that is suitable for both consecutive cutting and clamping actions.

According to the disclosure, a pair of locking pliers includes a first locking unit, a second locking unit, a linking member and a switching member.

The first locking unit includes a first handle that has opposite end portions, a first jaw that is fixedly connected to one of the opposite end portions of the first handle, and a stopping surface that is disposed in the first handle between the opposite end portions of the first handle.

The second locking unit includes a second handle that is spaced apart from the first handle, and that has opposite end portions, and a second jaw that is pivotally connected to the first locking unit and one of the opposite end portions of the second handle at a first connecting point and a second connecting point, respectively.

The linking member is disposed between the first and second handles, and has a pivot end portion, an abutment end portion and a contact surface. The pivot end portion is pivotally connected to the second handle at a third connecting point. The abutment end portion is opposite to the pivot end portion, and abuts against the stopping surface at a fourth connecting point such that the first locking unit, the second handle, the second jaw and the linking member cooperate to form a four-bar linkage structure, in which the first, second, third and fourth connecting points serve as the four joints of the four-bar linkage structure, and that movement of one of the second handle, the second jaw and the linking member relative to the first locking unit results in a compound movement of the second handle, the second jaw and the linking member relative to the same.

The switching member is pivotally connected to the linking member, and is convertible relative to the same between a blocking position, where the switching member is disposed between the contact surface of the linking member and the second handle to prevent direct contact therebetween such that, during the compound movement of the second handle, the second jaw and the linking member relative to the first locking unit, the second, third and fourth connecting points are prohibited from becoming col linear, and an unblocking position, where the switching member is distal from the contact surface of the linking member to allow direct contact between the contact surface of the linking member and the second handle such that, during the compound movement of the second handle, the second jaw and the linking member relative to the first locking unit, the second, third and fourth connecting points are allowed to become collinear.

### BRIEF DESCRIPTION OF THE DRAWINGS

Other features and advantages of the disclosure will become apparent in the following detailed description of the embodiment with reference to the accompanying drawings, of which:

FIG. 1 is a top plan view illustrating a pair of conventional locking pliers;

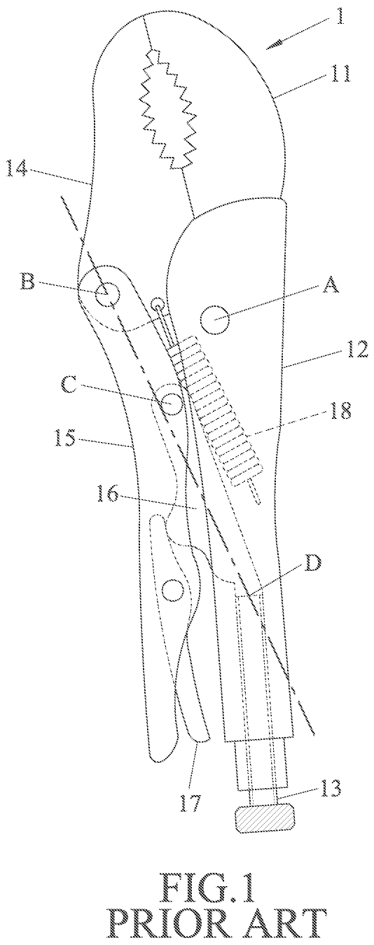

FIG. 2 is an exploded perspective view illustrating an embodiment of a pair of locking pliers according to the disclosure;

FIG. 3 is a perspective view of the embodiment;

FIG. 4 is a sectional view of the embodiment, illustrating a switching member at a blocking position;

FIG. 5 is another sectional view of the embodiment, illustrating a first connecting point, a second connecting point, a third connecting point and a fourth connecting point serving as the four joints of a four-bar linkage structure;

FIG. 6 is yet another sectional view of the embodiment, illustrating the switching member at an unblocking position, and the second, third and fourth connecting points being collinear;

FIG. 7 is a fragmentary sectional view taken along line VII-VII of FIG. 5; and

FIG. 8 is a sectional view of a variation of the embodiment.

### DETAILED DESCRIPTION

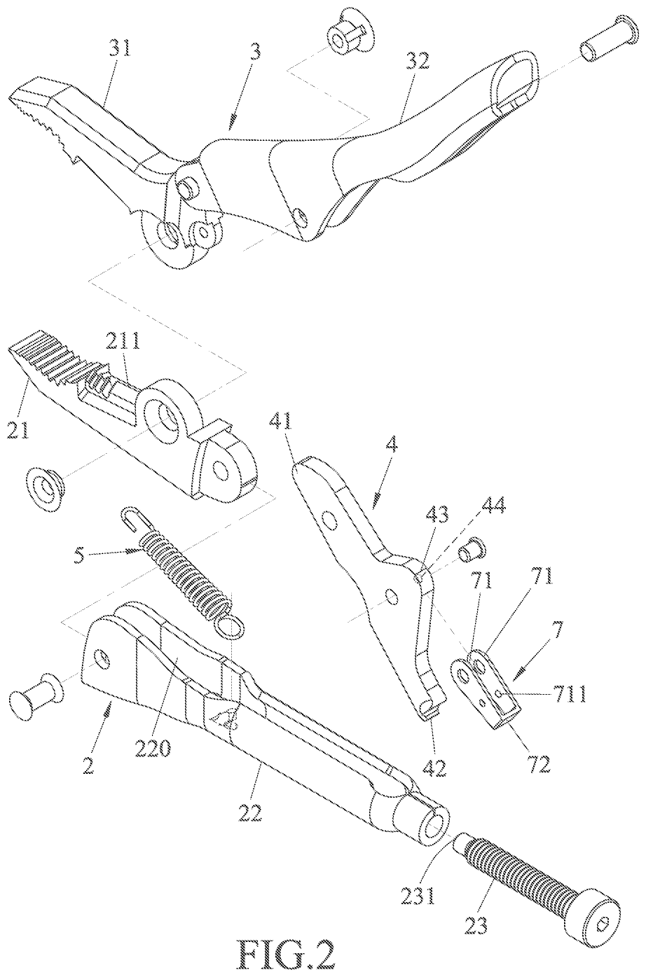

Referring to FIGS. 2, 3 and 4, a pair of locking pliers according to the disclosure includes a first locking unit 2, a second locking unit 3, a linking member 4, a resilient member 5 and a switching member 7.

The first locking unit 2 includes a first jaw 21, a first handle 22 and an adjustment bolt 23.

The first handle 22 has opposite end portions, and defines a first receiving space 220 that extends between the opposite end portions of the first handle 22 along the length of the first handle 22. The first jaw 21 is fixedly connected to one of the opposite end portions of the first handle 22, and has a first cutting portion 211. The adjustment bolt 23 extends through the other one of the opposite end portions of the first handle 22 into the first receiving space 220, and is threadably engaged with the first handle 22. The adjustment bolt 23 has a stopping surface 231 formed on an end thereof that is received in the first receiving space 220 such that the stopping surface 231 is disposed in the first handle 22 between the opposite end portions of the first handle 22.

The second locking unit 3 includes a second jaw 31 and a second handle 32.

The second handle 32 is spaced apart from the first handle 22, defines a second receiving space 320, and has opposite end portions and a convex inner surface 321. The second receiving space 320 extends between the opposite end portions of the second handle 32 along the length thereof, and is opened towards the first locking unit 2. Specifically, the first receiving space 220 of the first locking unit 2 and the second receiving space 320 of the second locking unit 3 are opened towards each other. The convex inner surface 321 is disposed in the second receiving space 320.

The second jaw 31 is pivotally connected to the first jaw 21 and one of the opposite end portions of the second handle 32 at a first connecting point (A) and a second connecting point (B), respectively. The second jaw 31 has a second cutting portion 311 that is opposite to the first cutting portion 211 of the first jaw 21. When the first and second cutting portions 211, 311 are spaced apart from each other, they cooperatively define a cutting space 30 therebetween.

The linking member 4 is disposed between the first and second handles 22, 32, and has a pivot end portion 41, an abutment end portion 42, a contact portion 43 and a first engaging portion 44.

The pivot end portion 41 is received in the second receiving space 320, and is pivotally connected to the second handle 32 at a third connecting point (C). The abutment end portion 42 is opposite to the pivot portion 41, is received in the first receiving space 220, and movably abuts against the stopping surface 231 of the adjustment bolt 23 at a fourth connecting point (D) such that the first locking unit 2, the second handle 32, the second jaw 31 and the linking member 4 cooperate to form a four-bar linkage structure, in which the first, second, third and fourth connecting points (A, B, C, D) serve as the four joints of the four-bar linkage structure, and that movement of one of the second handle 32, the second jaw 31 and the linking member 4 relative to the first locking unit 2 results in a compound movement of the second handle 32, the second jaw 31 and the linking member 4 relative to the same.

The contact portion 43 is connected between the pivot portion 41 and the abutment portion 42, and is formed with a contact surface 431 that is movable for direct contact with the convex inner surface 321 of the second handle 32. Specifically, the convex inner surface 321 of the second handle 32 faces the linking member 4, and is configured to abut against one of the contact portion 43 of the linking member 4 and the switching member 7, which will be described in further detail hereinafter.

The first engaging portion 44 is disposed at the contact portion 43, and is configured as a cavity.

The resilient member 5 is connected between the first handle 22 and the second jaw 31 and exerts a tension therebetween that biases the first and second jaws 22, 31 away from each other.

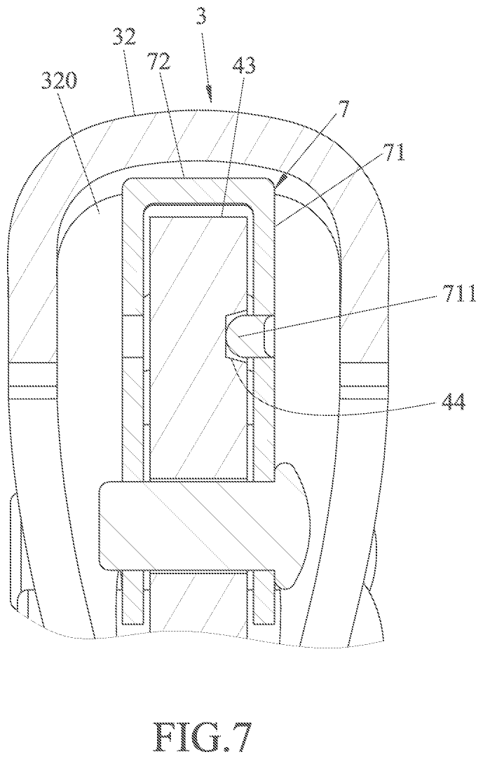

The switching member 7 is pivotally connected to the linking member 4, and has two swing arms 71 and a blocking portion 72. The blocking portion 72 is connected between the swing arms 71. The swing arms 71 are pivotally connected to the contact portion 43 of the linking member 4, and one of the swing arms 71 has a second engaging portion 711 that is configured as a protrusion such that the first engaging portion 44 of the linking member 4 and the second engaging member 711 are complementary in shape with each other (see FIG. 7).

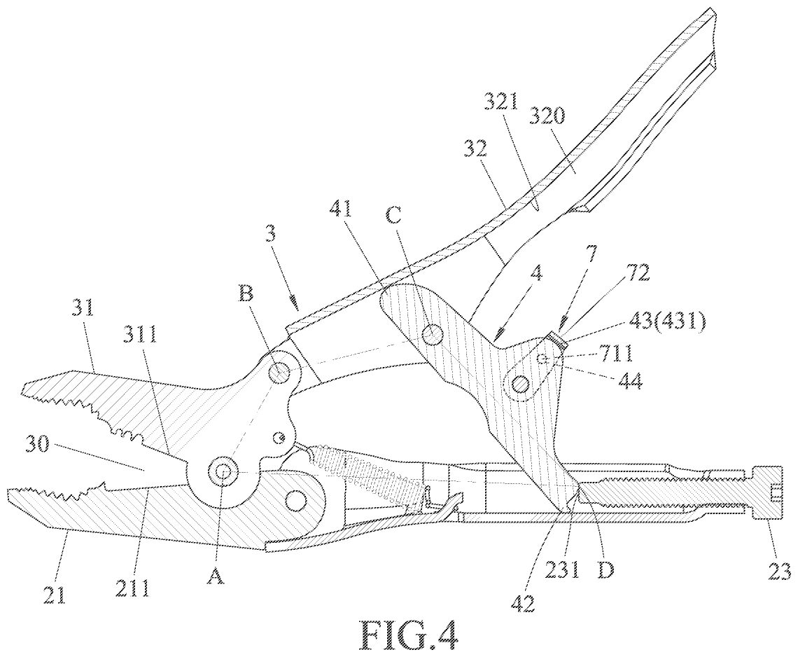

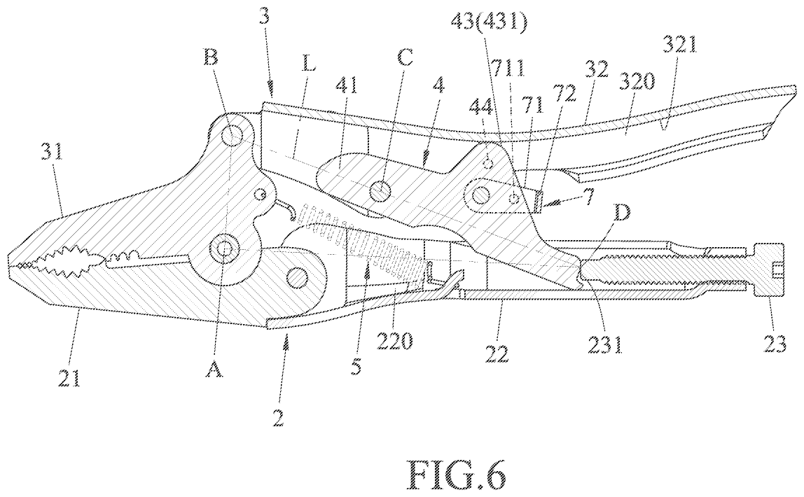

The switching member 7 is convertible relative to the linking member 4, between a blocking position (see FIGS. 4, 5 and 7) and an unblocking position (see FIG. 6).

When the switching member 7 is at the blocking position, the blocking portion 72 of the switching member 7 is disposed between the contact surface 431 of the linking member 4 and the convex inner surface 321 of the second handle 32 to prevent direct contact therebetween such that, during the compound movement of the second handle 32, the second jaw 31 and the linking member 4 relative to the first locking unit 2, when the blocking portion 72 of the switching member 7 abuts against the convex inner surface 321 of the second handle 32, the second, third and fourth connecting points (B, C, D) are prohibited from becoming collinear.

When the switching member 7 is converted from the blocking position to the unblocking position, the blocking portion 72 is pivoted toward the abutment portion 42 of the linking member 4.

When the switching member 7 is at the unblocking position, the blocking portion 72 of the switching member 7 is distal from the contact surface 431 of the linking member 4 to allow direct contact between the contact surface 431 of the linking member 4 and the convex inner surface 321 of the second handle 32 such that, during the compound movement of the second handle 32, the second jaw 31 and the linking member 4 relative to the first locking unit 2, the second, third and fourth connecting points (B, C, D) are allowed to become collinear.

Referring to FIGS. 4, 5 and 7, to use the present embodiment of the locking pliers to perform consecutive cutting actions, the switching member 7 is converted to the blocking position.

To start a cutting action, an object (e.g., a wire or cable) is received in the cutting space 30, and the adjustment bolt 23 is adjusted to a predetermined position according to dimensions of the object.

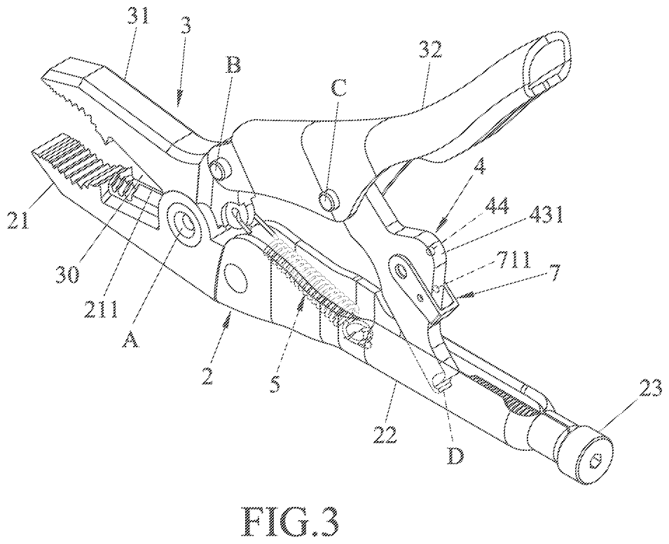

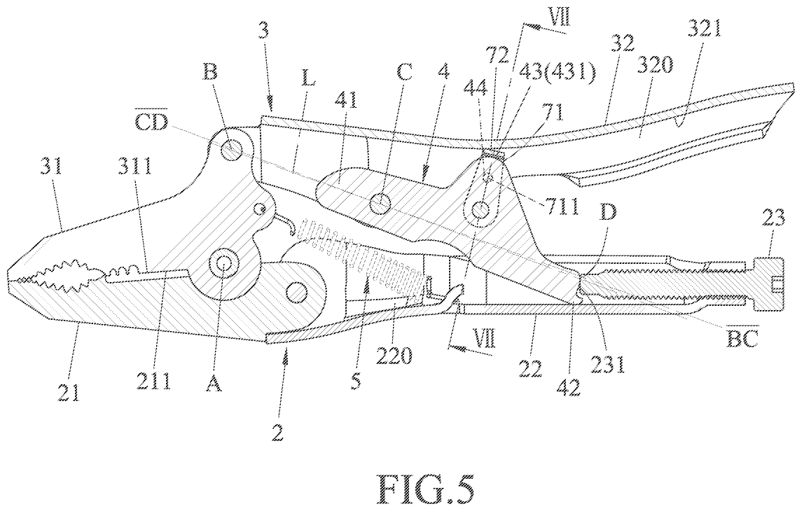

Next, the first and second handles 22, 32 are pressed towards each other, driving the first and second cutting portions 211, 311 of the first and second jaws 21, 31 towards each other to cut the object therebetween. During this process, the third connecting point (C) is moved toward the first handle 22. When the convex inner surface 321 of the second handle 32 abuts against the blocking portion 72 of the switching member 7, and when the object is fully cut such that the first and second jaws 21, 31 are closed towards each other, the third connecting point (C) is proximate to, but never coincides with, an imaginary line extending between the second and fourth connecting points (B, D) (see FIG. 5). That is, the third connecting point (C) does not become collinear with the second and fourth connecting points (B, D), and the imaginary lines B̅C̅ and C̅D̅ of FIG. 3 do not overlap each other. As such, the locking pliers are never brought into a locked state. After the cutting action, the first and second jaws 21, 31 are driven by the tension of the resilient member 5 to move away from each other and another cutting action may be performed.

Referring to FIG. 6, to use the present embodiment to perform a clamping action, the switching member 7 is converted to the unblocking position.

To start the clamping action, an object (e.g., a bolt) is disposed between the first and second jaws 21, 31 but not received in the cutting space 30, and the adjustment bolt 23 is adjusted to a predetermined position according to dimensions of the object.

Next, the first and second handles 22, 32 are pressed towards each other, driving the first and second jaws 21, 31 towards each other to clamp the object therebetween. During this process, the third connecting point (C) is moved toward the first handle 22 to coincide with the imaginary line extending between the second and fourth connecting points (B, D); that is, the third connecting point (C) arrives at a dead point of the four-bar linkage structure and becomes collinear with the second and fourth connecting points (B, D). At this time, the convex inner surface 321 of the second handle 32 abuts against the contact portion 43 of the linking member 4, and the object is clamped between the first and second jaws 21, 31. Once the third connecting point (C) passes the dead point, the locking pliers are brought into the locked state, where the third connecting point (C) is prevented from returning to the dead point, and the object is thus securely clamped between the first and second jaws 21, 31.

To release the locking pliers from the locked state, the first and second handles 22, 32 have to be pulled away from each other, thereby allowing the third connecting point (C) to return to and pass the dead point so as to move away from the first handle 22.

It should be noted that, when the switching member 7 is at the blocking position, the first engaging portion 44 of the linking member 4 and second engaging portion 711 of the switching member 7 are engaged with each other such that the switching member 7 is positioned relative to the linking member 4.

In addition, configurations of the first and second engaging portions 44, 711 are not limited to the present embodiment as long as they are complementary in shape with or engageable with each other. For example, in other embodiments of the disclosure, the first engaging portion 44 of the linking member 4 may instead be configured as the protrusion, and the second engaging portion 711 of the switching member 7 may be configured as the cavity.

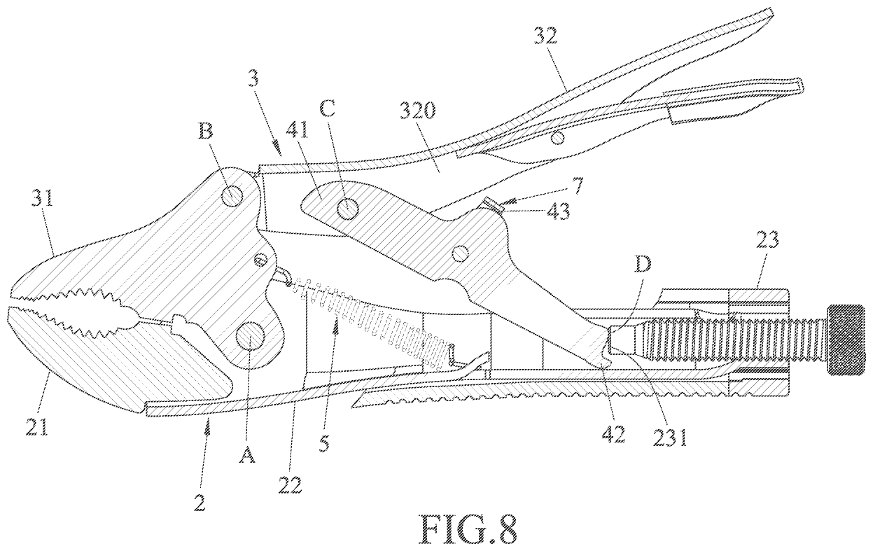

It should also be noted that, the second jaw 31 of the second locking unit 3 is not limited to be connected to the first jaw 21 of the first locking unit 2. For example, in a variation of the embodiment, as shown in FIG. 8, the second jaw 31 is pivotally connected to the first handle 22 of the first locking unit 2 at the first connecting point (A).

In sum, the present embodiment of the locking pliers according to the disclosure has the following advantages.

By virtue of the switching member 7 being convertible between the blocking and unblocking positions, the present embodiment is suitable for both clamping and consecutive cutting actions. Moreover, by virtue of the configurations of the switching member 7 and the linking member 4, the switching member 7 can be easily converted between the blocking and unblocking positions in a matter of seconds, which is rather convenient for users.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pair of locking pliers comprising:
a first locking unit including
a first handle that has opposite end portions,
a first jaw that is fixedly connected to one of said opposite end portions of said first handle, and
a stopping surface that is disposed in said first handle between said opposite end portions of said first handle;
a second locking unit including
a second handle that is spaced apart, from said first handle, and that has opposite end portions, and
a second jaw that is pivotally connected to said first locking unit and one of said opposite end portions of said second handle at a first connecting point and a second connecting point, respectively;
a linking member disposed between said first and second handles, and having
a pivot end portion that is pivotally connected to said second handle at a third connecting point,
an abutment end portion that is opposite to said pivot portion, and that abuts against said stopping surface at a fourth connecting point such that said first locking unit, said second handle, said second jaw and said linking member cooperate to form a four-bar linkage structure, in which the first, second, third and fourth connecting points serve as the four joints of the four-bar linkage structure, and that movement of one of said second handle, said second jaw and said linking member relative to said first locking unit results in a compound movement of said second handle, said second jaw and said linking member relative to the same, and
a contact surface; and
a switching member pivotally connected to said linking member, and being convertible relative to the same between
a blocking position, where said switching member is disposed between said contact surface of said linking member and said second handle to prevent direct contact therebetween such that, during the compound movement of said second handle, said second jaw and said linking member relative to said first locking unit, the second, third and fourth connecting points are prohibited from becoming collinear, and
an unblocking position, where said switching member is distal from said contact surface of said linking member to allow direct contact between said contact surface of said linking member and said second handle such that, during the compound movement of said second handle, said second jaw and said linking member relative to said first locking unit, the second, third and fourth connecting points are allowed to become collinear.

2. The pair of locking pliers as claimed in claim 1, wherein said linking member further has a contact portion that is connected between said pivot portion and said abutment portion, and that is formed with said contact surface, which is movable for direct contact with said second handle when said switching member is at the unblocking position.

3. The pair of locking pliers as claimed in claim 2, wherein:
said switching member has at least one swing arm that is pivotally connected to said contact portion of said linking member, and a blocking portion that is connected to said at least one swing arm; and
when said switching member is converted from the blocking position to the unblocking position, said blocking portion is pivoted toward said abutment portion of said linking member.

4. The pair of locking pliers as claimed in claim 3, wherein:
said linking member further has a first engaging portion that is disposed at said contact portion;
said at least one of said swing arm of said switching member has a second engaging portion;
when said switching member is at the blocking position, said first and second engaging portions are engaged with each other such that switching member is positioned relative to said linking member; and
said first engaging portion is configured as one of a protrusion and a cavity that are complementary in shape with each other, said second engaging portion being configured as the other one of the protrusion and the cavity.

5. The pair of locking pliers as claimed in claim 1, wherein said first handle of said first locking unit defines a first receiving space that extends between said opposite end portions of said first handle along the length thereof, and that is opened towards said second locking unit, said abutment portion of said linking member being received in said first receiving space.

6. The pair of locking pliers as claimed in claim 5, wherein said second handle of said second locking unit defines a second receiving space that extends between said opposite end portions of said second handle along the length thereof, and that is opened towards said first locking unit, said pivot portion of said linking member being received in said second receiving space.

7. The pair of locking pliers as claimed in claim 5, wherein said second handle has a convex inner surface that faces said linking member, and that is configured to abut against said switching member when said switching member is at the blocking position.

8. The pair of locking pliers as claimed in claim 5, wherein said first locking unit further includes an adjustment bolt that extends through one of said opposite end portions of said first handle into said first receiving space, and that is threadedly engaged with said first handle, said stopping surface being formed on an end of said adjustment bolt that is received in said first receiving space.

9. The pair of locking pliers as claimed in claim 1, wherein said second jaw is pivotally connected to said first jaw of said first locking unit at the first connecting point.

10. The pair of locking pliers as claimed in claim 1, wherein said second jaw is pivotally connected to said first handle of said first locking unit at the first connecting point.
